(19) United States
(12) Patent Application Publication
(10) Pub. No.: US 2010/0263745 A1
(43) Pub. Date: Oct. 21, 2010

(54) DRAIN PLUG

(76) Inventor: James Andrew SYMES, Upper Hut (NZ)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/426,180

(22) Filed: Apr. 17, 2009

(51) Int. Cl. F16K 15/04

(52) U.S. Cl. 137/528

(57) ABSTRACT

A drain plug for controlling the flow of a liquid through a drain hole. The drain plug has a drain plug body with a drain passage extending partly through the drain plug body. The drain passage has at least one outlet port. The drain plug has a check valve for allowing the flow of the liquid through the drain passage in a first direction and substantially inhibiting the flow of liquid through the drain passage in a second opposite direction. The drain plug is moveable relative to a drain hole between at least one open position in which the at least one outlet port is exposed or open and liquid may flow through the passage and at least one closed position in which the at least one outlet port is covered or closed by the drain hole housing to substantially inhibit liquid flowing through the passage.

### FIELD OF THE INVENTION

This invention relates to a drain plug for controlling the flow of a liquid through a drain hole.

### BACKGROUND

Boat hulls often partly fill with water when they are used in the sea or lake, for example. Many boats have a drain hole positioned towards a lower surface of the boat hull for allowing water to escape from the interior of a boat hull or bilge. The drain hole is usually closed by a drain plug. Typically after each use, a boat user will remove their boat from the water and store it on land, for example on a trailer or boat rack- After the boat has been removed from the water, the drain plug is removed from the drain hole, which allows the water that has collected in the boat to drain through the drain hole and out of the boat. It is common for the drain plug to be left out of the drain hole while the boat remains in storage.

When the boat is in use, for example out at sea, the drain hole needs to be closed by the drain plug to prevent water entering the boat hull through the drain hole, which may cause the boat to sink. However, it is not uncommon for boat users to forget to replace the drain plug and ensure the drain hole is closed. Usually, when the boat is travelling in a forward direction, the water does not enter the boat hull through the drain hole. However, when the boat stops travelling, water can begin to enter the boat through the drain hole. It is at that stage, that the boat user will realise the drain plug has not be replaced in the drain hole. It is often too late or too difficult to then put the drain plug in the drain hole. Also, the boat can often be a long way from shore making it difficult to return to shore and replace the drain plug.

A number of drain plugs and bilge management systems have been developed to help control the flow of water through a drain hole and prevent water entering the boat through the drain hole if the boat users forget to close the drain hole before using the boat in the water. Examples of those drain plugs are described below.

U.S. Pat. No. 4,649,952 describes a combined shut-off and check valve. The valve has a ball valve closure for opening and closing the valve, a ball, a seat, and a ramp. When the ball valve closure is in the open position and the boat is in use in the water, there is a pressure differential across the valve housing, which urges the ball up the ramp to the seat, which closes the valve.

U.S. Pat. No. 4,217,846 describes a boat bailing apparatus having a ball closure member for engaging a seat member to prevent flow of water through apparatus. In addition, the apparatus may have a hand-operated shut-off valve in the form of a frusto-conical closure member or plug.

U.S. Pat. No. 3,565,031 describes a boat bailer having a housing with a rotatable valve element. A ball check valve is positioned within a rotatable valve member that closes the drain of the valve. The boat bailer has a handle for controlling the position of the rotatable valve member and closing the drain.

U.S. Pat. No. 6,973,891 describes a self-closing boat drain plug apparatus. The apparatus has a ball check valve and a shut-off valve assembly. The shut-off valve assembly has a blockage member that is controlled by an external handle.

The devices described in the patents listed above are complicated devices that involve a number of moving parts. A common characteristic of those devices is that they have a manual-type turn off operation that is performed from the inside of the boat. This limits their use in both modern and older boats because access to the drain hole from the inside is usually limited. Modem boats have a number of components and other parts that obstruct access to the drain hole and older boats have a drain hole under a sealed floor. Also, when the boat has an inboard motor, there is usually no way to reach the drain hole from the inside of the boat. Further, some of the devices described in the patents listed above can not be easily retrofitted to existing boats and will require the entire drain hole housing and drain plug to be replaced.

In this specification where reference has been made to patent specifications, other external documents, or other sources of information, this is generally for the purpose of providing a context for discussing the features of the invention Unless specifically stated otherwise, reference to such external documents or such sources of information is not to be construed as an admission that such documents or such sources of information, in any jurisdiction, are prior art or form part of the common general knowledge in the art.

It is an object of at least preferred embodiments of the present invention to provide a drain plug for controlling the flow of a liquid through a drain hole that overcomes the problems associated with known drain plugs, or to at least provide the public with a useful alternative.

### SUMMARY OF THE INVENTION

In one aspect the invention provides a drain plug for controlling the flow of a liquid through a drain hole comprising:
a drain plug body having a drain passage extending partly through the drain plug body, the drain passage having at least one outlet port;
a check valve for allowing the flow of the liquid through the drain passage in a first direction and substantially inhibiting the flow of liquid through the drain passage in a second opposite direction;
wherein the drain plug is moveable relative to a drain hole between at least one open position in which the at least one outlet port is exposed or open and liquid may flow through the passage and at least one closed position in which the at least one outlet port is covered or closed by the drain hole housing to substantially inhibit liquid flowing through the passage.

Preferably, the drain plug further comprises a stopper integrally formed with the drain plug body.

Preferably, the check valve comprises a ball valve, the ball valve having a ball positioned within the drain passage of the drain plug body, wherein the ball is moveable between at least one open position in which liquid may flow through the passage in the first direction and a closed position in which the ball substantially inhibits the flow of liquid through the drain passage in the second opposite direction.

Preferably, the drain plug is moveable between the open and closed positions by rotating the drain plug relative to the drain hole about a longitudinal axis of the drain plug body.

Preferably, the drain plug body has a substantially circular cross section corresponding to a substantially circular internal cross section of the drain hole.

Preferably, the drain plug body has an external thread and the drain hole has a corresponding internal thread.

Preferably, the drain plug body is elongate.

Preferably, the stopper has a cross section that is larger than a cross section of the drain plug body.

Preferably, the drain plug further comprises a seal or O-ring that forms a seat for the ball when the ball is in the closed position.

Preferably, the drain passage extends along the longitudinal axis of the drain plug body.

Preferably, the drain passage comprises a main drain passage section and at least one port extending outwardly from the main drain passage section through the sidewall of the drain plug body.

Preferably, the at least one port extends laterally from the main drain passage section through the sidewall of the drain plug body.

In a second aspect, the invention provides a combination of a drain plug according to the first aspect together with a housing, the housing having a housing body and a drain hole adapted to receive the drain plug body.

Preferably, the housing has a flange extending outwardly from the housing body for attaching the housing to a boat.

Preferably, the stopper of the drain plug sealingly engages with the flange of the housing when the drain plug is in the closed position.

The term “comprising” as used in this specification means “consisting at least in part of”; that is to say when interpreting statements in this specification which include “comprising”, the features prefaced by this term in each statement all need to be present but other features can also be present. Related terms such as “comprise” and “comprised” are to be interpreted in a similar manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

As used herein the term “(s)” following a noun means the plural and/or singular form of that noun.

As used herein the term “and/or” means “and” or “or”, or where the context allows both.

The invention consists in the foregoing and also envisages constructions of which the following gives examples only.

### BRIEF DESCRIPTION OF THE DRAWINGS

The present invention will now be described with reference to the accompanying drawings in which:

FIG. 1 is a perspective view of the preferred embodiment drain plug;

FIG. 2 is an exploded perspective view of the drain plug of FIG. 1;

FIG. 3 is a perspective view of the drain plug of FIG. 1 in a closed position;

FIG. 4 is a perspective view of the drain plug of FIG. 1 in an open position;

FIG. 5 is a cross-sectional view of drain plug o f FIG. 1 installed in a boat with the drain plug in an open position ad the ball in an open position allowing liquid to flow through the drain passage from the interior of the boat to the exterior of the boat;

FIG. 6 is a cross-sectional view of the preferred embodiment drain plug installed in a boat with the drain plug in the open position and the ball in a closed position in which the ball substantially prevents water entering the drain hole from outside the boat.

### DETAILED DESCRIPTION OF A PREFERRED EMBODIMENT

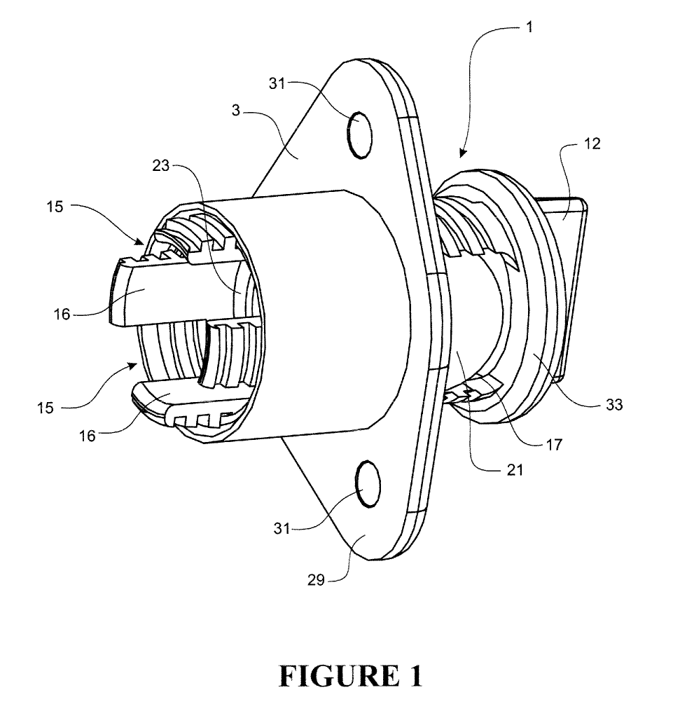

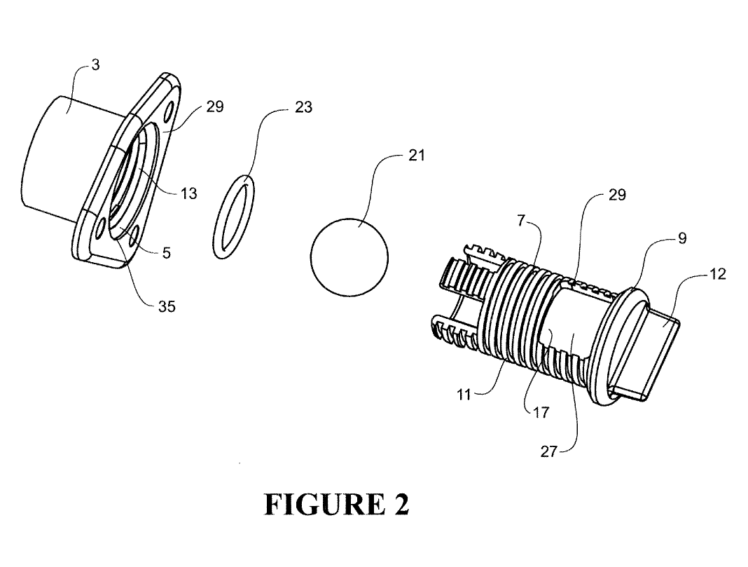

With reference to FIG. 1, a preferred embodiment of the drain plug is shown, indicated generally by reference number 1. The drain plug is used in combination with a drain hole housing 3 having a drain hole 5. The drain hole housing is typically attached to a lower surface of a boat hull for allowing water to escape from the interior of a boat hull or bilge. The drain plug is a safety drain plug that controls the flow of water through a drain hole of a boat. When the drain plug is used on a boat, it will substantially inhibit water entering the boat through the drain hole 5, regardless of whether the drain plug is in an open or a closed position.

The drain plug has an elongate drain plug body 7 and an integrally formed stopper 9. The drain plug body 7 has a substantially circular cross section corresponding to a substantially circular internal cross section of the drain hole 5. In addition, the drain plug body 7 has an external thread 11 corresponding to an internal thread 13 of the drain hole 5. The threads are preferably square threads. Alternatively the threads may be any other suitable thread style, such as an Acme thread, for example.

In the preferred embodiment shown, the stopper 9 is a wider end portion of the drain plug body 7. The shape Land size of the stopper 9 are chosen or designed so that the stopper can be gripped by hand and manually turned to open or close the drain plug. The drain plug preferably has a handle portion 12 to allow for manual operation of the drain plug. The other end of the drain plug body 7 has a wider cross section compared to the remainder of the body. The wider cross section substantially inhibits the drain plug from being accidentally or unintentionally removed from the housing 3. The other end of the drain plug body has open ended slots 15 and fingers 16 that allow compression of that end of the drain plug body when the drain plug is assembled with the housing.

The drain plug has a drain passage 17 extending through the drain plug body 7 and a check valve for controlling the flow of water through the drain passage. In the preferred embodiment shown, the check valve is a ball-check valve 19 having a ball 21 and a seat 23. The ball 21 and seat 23 are positioned within the drain passage 17 of the drain plug body 7. The seat 23 is preferably an O-ring or seal that is received and supported by a shoulder or groove formed in the interior of the drain plug body 7. Alternatively, the seat 23 may be an integrally formed shoulder or curved portion formed in the drain passage of the drain plug body 7. As described below, the ball 21 of the ball-check valve 19 is moveable between an open position and a closed seated position to control the flow of water through the drain passage 17.

The drain passage 17 comprises a main drain passage section 25 and at least one port 27 extending outwardly from the main drain passage section through the sidewall 29 of the drain plug body 7. In the preferred embodiment shown, the drain passage has one port 27 that extends laterally or in a radial direction from the main drain passage section 25 through the sidewall 29 of the drain plug body 7. Alternatively, the drain passage may have more than one port, for example, two or three ports. The port 27 allows water to flow from the main drain passage section 25 and out of the drain plug.

In the preferred embodiment shown, the drain plug is used with the drain hole housing 3. The drain hole housing 3 has a housing body 29 in which the drain hole 5 is formed. The drain hole is adapted to receive the drain plug body 7.

The drain hole housing 3 also has a flange 21 extending outwardly from the housing body. The flange 21 provides an area for attaching the housing to a boat, for example, by fasteners. In the preferred embodiment, the flange has apertures 31 for receiving fasteners for attaching the drain hole housing to the transom of a boat.

The flange 21 also provides an area against which the stopper 9 of the drain plug can seal, when the drain plug is in a closed position. In particular, the stopper 9 of the drain plug has an abutment face 33 that engages with a corresponding abutment face 35 of the flange 21 when the drain plug I is in the most closed position. The corresponding abutment faces seal the drain passage 1 to prevent water entering the drain passage from the stopper end when the drain plug is in the closed position. In some embodiments, the abutment face 33 of the stopper 9 may have a groove that receives and supports a seal or O-ring to improve the seal between the abutment faces and further inhibit the flow of water between the abutment faces. It will be appreciated that in alternative embodiments, the abutment faces may not completely seal the drain passage but will at least substantially inhibit water entering the drain passage from the stopper end when the drain plug is in the closed position.

The drain plug 1 and drain housing 3 are preferably formed from a suitable plastic material. Alternatively, the drain plug and drain housing may be formed from a suitable metallic material, such as brass or steel. If those components are formed from a metallic material, it will be appreciated that they will be galvanised or painted, for example, to prevent corrosion.

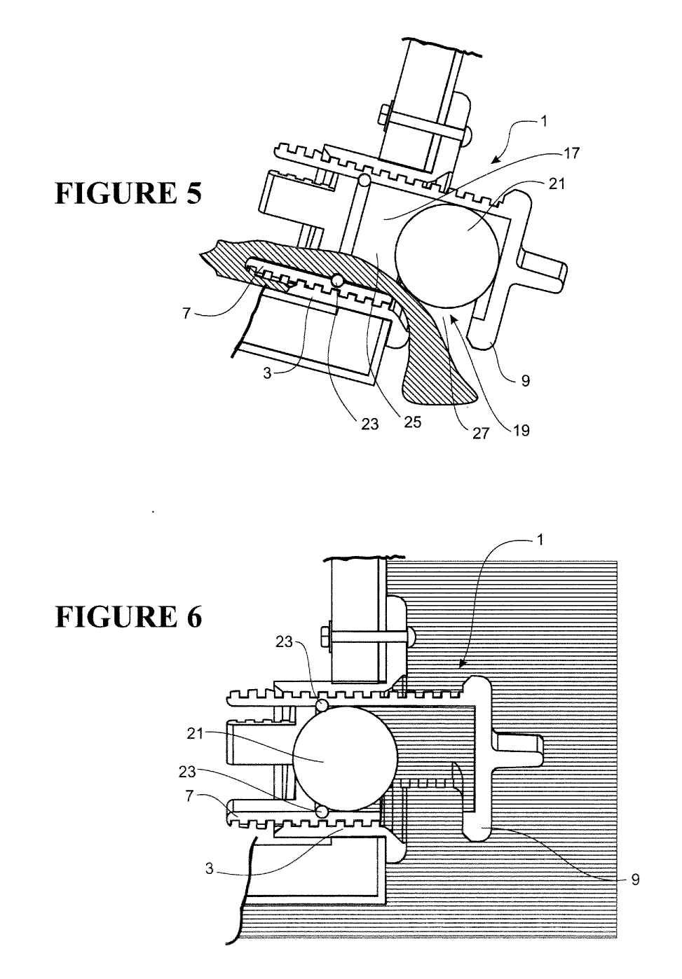

The operation of the drain plug 1 will now be described. FIG. 5 is a cross-sectional view of drain plug of FIG. 1 installed in a boat with the drain plug in an open position and the ball in an open position allowing liquid to flow through the drain passage from the interior of the boat to the exterior of the boat. FIG. 6 is a cross-sectional view of the preferred embodiment drain plug installed in a boat with the drain plug in the open position and the ball in a closed position in which the ball substantially prevents water entering the drain hole from outside the boat.

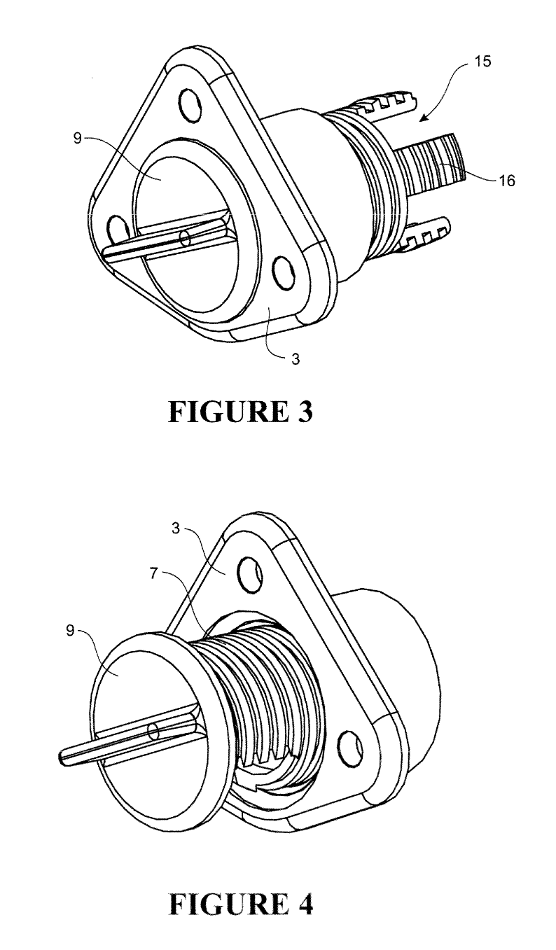

The drain plug 1 is moveable relative to the drain hole housing 3 between at least one open position (shown in FIGS. 4 and 5) in which liquid may flow through the passage and at least one closed position (shown in FIGS. 3 and 6, in which the stopper 9 substantially inhibits liquid flowing through the passage. The drain plug 1 is moveable between the various open and closed positions by rotating the drain plug 1 relative to the drain hole housing 3 about a longitudinal axis of the drain plug body 7.

With reference to FIGS. 4 and 5, the drain plug 1 is in an open position when at least a portion of the lateral port is free from the housing and water can flow from the drain passage and out through the lateral port. The drain plug 1 can be moved to additional open positions by rotating the drain plug relative to the drain hole housing in an anti-clockwise direction and exposing more of the lateral port 27.

When the drain plug 1 is in the open position, the drain plug allows water to flow from the interior of the boat, through the drain passage and out of the drain plug through the port 27. When a boat user has moved their boat onto shore and wishes to empty water from the boat hull, they can torn the drain plug 1 until it reaches an open position, which will allow water to empty from the boat hull. It is not necessary to completely remove the drain plug from the drain hole to empty the boat of water.

An advantage of the drain plug 1 described is that when the boat is placed in the water with the drain plug in the open position, water will be prevented or at least substantially inhibited from entering the boat through the drain hole 5 through the action of the ball check valve 19. The ball 21 of the ball check valve 19 is moveable between at least one open position and a closed position. In the open positions, liquid may flow through the drain passage 17 in the first direction, that is, in a direction from the interior of the boat to the exterior of the boat. In the closed position, the ball 21 substantially inhibits the flow of liquid through the drain passage in the second opposite direction, that is, from outside the boat towards the interior of the boat.

With reference to FIG. 6, when the boat is placed in the water with the drain plug 1 is in the open position, the pressure of the water outside the boat will cause the ball 21 to seat against the seat 23 and block the drain passage 17 to prevent or at least substantially inhibit water from entering the boat through the drain hole 5. Accordingly, it is not necessary to close the drain plug 1 after the boat has been emptied of water and before the boat is used in the water again.

Although it is not necessary to close the drain plug 1 before the boat is used in the water again, the drain plug may be closed, as shown in FIG. 3. The drain plug 1 is closed by rotating the drain plug relative to the drain hole about a longitudinal axis of the drain plug body The drain plug 1 is in a closed position when the lateral port is covered by the housing and water is prevented from entering or leaving the drain passage through the lateral port. The drain plug 1 can be moved to further closed positions by rotating the drain plug relative to the drain hole housing in a clockwise direction. The drain plug 1 is in the most closed position when the corresponding abutment faces of the stopper 9 and flange engage together to seal the drain passage. When the drain plug 1 is in a closed position, water is prevented or is at least substantially inhibited from entering the boat through the drain passage of the drain plug.

In the preferred embodiment described, the drain plug 1 is provided in combination with a drain hole housing 3. In an alternative embodiment, the drain plug may be provided as a single component and retrofitted to an existing drain hole housing or an existing drain hole in a boat

Preferred embodiments of the invention have been described by way of example only and modifications may be made thereto without departing from the scope of the invention.

For example, the preferred embodiment drain plug described above has a drain plug body and a stopper, which is a wider end portion of the drain plug body. In an alternative embodiment, the drain plug may be provided without a wider stopper. In this embodiment, the drain passage and port(s) may be spaced further towards the free end of the drain plug. The drain plug can be closed by moving the drain plug towards the drain plug housing until the lateral port(s) are covered by the housing and water is prevented or at least substantially inhibited from entering or leaving the drain passage through the lateral port(s).

The drain plug has been described for use in boating applications to prevent or at least substantially inhibit water entering a boat hull when the boat is in water. However, it will be appreciated that the drain plug may be used in other applications requiring a drain plug that has an open position in which the drain plug allows a liquid to flow in one direction and inhibit the liquid flowing in the opposite direction and a closed position in which the liquid is inhibited from flowing through the drain plug.

1. A drain plug for controlling the flow of a liquid through a drain hole comprising:
a drain plug body having a drain passage extending partly through the drain plug body, the drain passage having at least one outlet port,
a check valve for allowing the flow of the liquid through the drain passage in a first direction and substantially inhibiting the flow of liquid through the drain passage in a second opposite direction;
wherein the drain plug is moveable relative to a drain hole between at least one open position in which the at least one outlet port is exposed or open and liquid may flow through the passage and at least one closed position in which the at least one outlet port is covered or closed by the drain hole housing to substantially inhibit liquid flowing through the passage.

2. A drain plug as claimed in claim 1, wherein the drain plug further comprises a stopper integrally formed with the drain plug body.

3. A drain plug as claimed in claim 1, wherein the check valve comprises a ball valve, the ball valve having a ball positioned within the drain passage of the drain plug body, wherein the ball is moveable between at least one open position in which liquid may flow through the passage in the first direction and a closed position in which the ball substantially inhibits the flow of liquid through the drain passage in the second opposite direction.

4. A drain plug as claimed in claim 1, wherein the drain plug is moveable between the open and closed positions by rotating the drain plug relative to the drain hole about a longitudinal axis of the drain plug body.

5. A drain plug as claimed in claim 1, wherein the drain plug body has a substantially circular cross section corresponding to a substantially circular internal cross section of the drain hole.

6. A drain plug as claimed in claim 1, wherein the drain plug body has an, external thread and the drain hole has a corresponding internal thread.

7. A drain plug as claimed in claim 1, wherein the drain plug body is elongate.

8. A drain plug as claimed in claim 1, wherein the stopper has a cross section that is larger than a cross section of the drain plug body.

9. A drain plug as claimed in claim 1, further comprising a seal or O-ring that forms a seat for the ball when the hall is in the closed position.

10. A drain plug as claimed in claim 1, wherein the drain passage extends along the longitudinal axis of the drain plug body.

11. A drain plug as claimed in claim 1, wherein the drain passage comprises a main drain passage section and at least one port extending outwardly from the main drain passage section through the sidewall of the drain plug body.

12. A drain plug as claimed in claim 1, wherein the at least one port extends laterally from the main drain passage section through the sidewall of the drain plug body.

13. The combination of a drain plug according to claim 1 together with a housing, the housing having a housing body and a drain hole adapted to receive the drain plug body.

14. The combination of a drain plug together with a housing as claimed in claim 13, wherein the housing has a flange extending outwardly from the housing body for attaching the housing to a boat.

15. The combination of a drain plug together with a housing as claimed in claim 13, wherein the stopper of the drain plug sealingly engages with the flange of the housing when the drain plug is in the closed position.
